(19) United States
(12) Patent Application Publication
(10) Pub. No.: US 2005/0108316 A1
(43) Pub. Date: May 19, 2005

(54) Methods and systems for organizing related communications

(75) Inventors: Diana Maria Cantu, Austin, TX (US); Satish Jaganeth Parolkar, Austin, TX (US)

Correspondence Address: HARNESS, DICKEY & PIERCE, P.L.C., P.O. Box 8910, Reston, VA, 20195, US

(73) Assignee: SBC Knowledge Ventures, L.P.

(21) Appl. No.: 10/716,172

(22) Filed: Nov. 18, 2003

(51) Int. Cl. G06F 15/16

(52) U.S. Cl. 709/200

(57) ABSTRACT

Related communications are organized in one or more databases even though communications may originate from different devices (e.g., facsimile machines, telephone voicemail systems, etc . . . ). Once organized, the communications are easily retrieved. Extensible mark-up language (“XML”) based messages, using substantially the same Document Type Definition (“DTD”), associated with the communications are exchanged between a mediation web server and one or more client web servers to allow communications in diverse formats to be exchanged and compared to previously stored messages to determine if they are related and stored in one or more appropriate databases.

### BACKGROUND OF THE DISCLOSURE

Given the many ways in which a customer may choose to communicate with a company selling a product or service, it is becoming more and more necessary for such a company to have in place an effective system for ensuring that all communications related to a single customer or transaction are stored in one, easy-to-access, place. Without such a system, a customer's communications may be lost, or become inaccessible, which is just as bad. The inability to find or access customer communications and the information contained therein slows down the transaction between the customer and company. For example, sometimes customers are asked to resend information they have previously sent. Worst case, the customer may decide that it is not worth the time and trouble to resend the information leading to the cancellation of the transaction and a loss of business for the company.

Whether it be voicemails which are erased, faxes which are misplaced, or emails which are inaccessible, the inability to organize these different types of communications into one easy-to-access record is a problem faced by many companies today.

Accordingly, it is desirable to provide methods and systems which provide a company or another entity the ability to organize related, customer communications in a way that reduces the chances that these communications will be lost or erased, and makes such communications easily accessible to a customer agent or the like responsible for responding to, or processing, customer transactions.

### BRIEF DESCRIPTION OF THE DRAWINGS

FIG. 1 is a simplified block diagram illustrating the flow of communications from many different communications devices to one or more databases according to one embodiment of the present invention.

FIG. 2 depicts a simplified flow diagram illustrating methods for organizing related databases according to one or more embodiments of the present invention.

### DETAILED DESCRIPTION OF THE DRAWINGS

The present disclosures provides for methods and systems which organize related communications in one or more databases even though messages may originate from different communication devices (e.g., facsimile machines, telephone voicemail systems, etc. . . ). Once organized, the messages are easily retrieved. One system includes a web server operable to receive at least one customer associated, extensible mark-up language (“XML”)-based message (e.g., representing a fax, email or voicemail message). The use of XML-based messages advantageously allows the web server to receive messages which originate from diverse communication devices. After receiving the message the web server is operable to compare one or more XML tags within the message to one or more references, wherein each reference is associated with one or more previously received and stored messages. If a match occurs, the message is converted into a format associated with at least one database (e.g., Oracle, Sybase) to allow the message to be stored along with other previously received, related messages. The web server makes use of a Document Type Definition (“DTD”) to send and receive XML messages to and from communication devices.

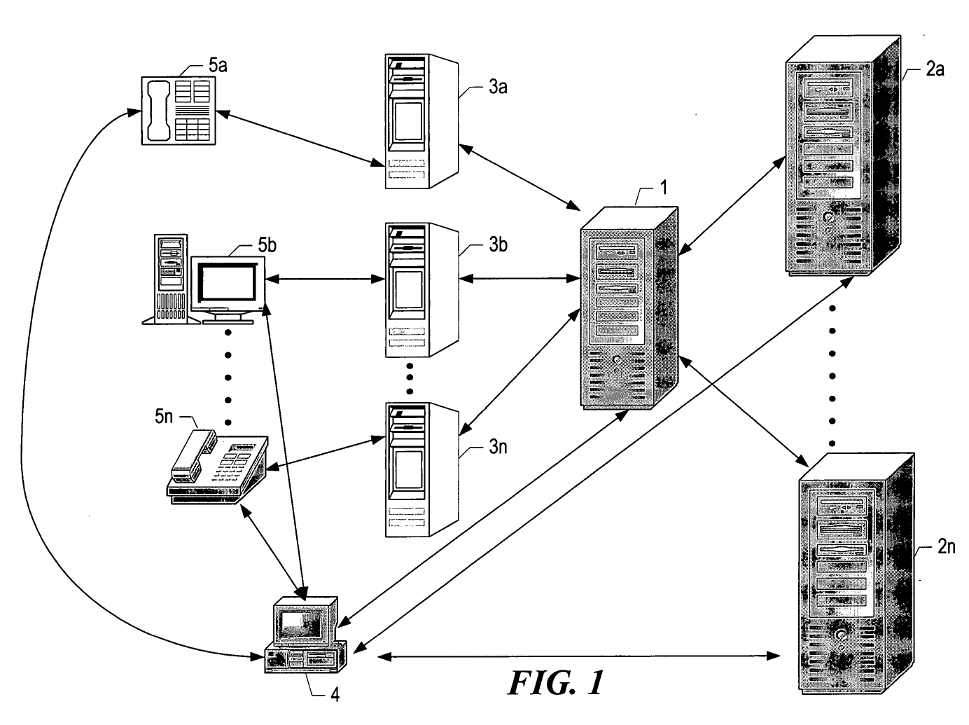

Referring now to FIG. 1, there is shown a plurality of input communication devices 5a, 5b, . . . 5n (where “n” indicates the last such device). Each input communication device 5a, 5b, . . . 5n is connected to an associated communication control device 3a, 3b, . . . 3n (where “n” again indicates the last such device). For example, input device 5a may comprise a facsimile machine, device 5b a desktop computer, while device 5n may comprise a wired, or wireless telephone handset or other device. Similarly, communication control device 3a may comprise a fax server, device 3b an email server, and device 3n a voicemail server (devices 3a,3b, . . . 3n may individually or collectively be referred to as “client server”). It should be understood that while only three input devices 5a, 5b, . . . 5n and three communication control devices 3a, 3b, . . . 3n are shown, that more or less input or control devices may be added or removed without departing from the spirit or scope of the present invention. The role of the communication control devices 3a, 3b, . . . 3n is to, for example, store, process and forward a specific type of customer communication (e.g., voice, fax, email, etc.) on to a mediation web server 1. In accordance with one aspect of the present invention, once the communications have been received by the mediation web server 1, they are stored in an appropriate database 2a, . . . 2n (where “n” again represents the last database). The mediation web server 1 is operable to determine, for example, the identity of the customer who sent a present incoming message. It is also operable to determine which database 2a, . . . 2n is presently being used to store previous communications or messages (hereinafter collectively referred to as “messages” or “communications”) that are related to the present message(s). Because it can identify present messages and locate an appropriate database (or databases), the mediation web server 1 is able to organize or otherwise group messages which are related to one another in one or more databases 2a, . . . 2n.

For example, suppose a customer is interested in obtaining a home mortgage. The customer might fax in a mortgage application using a fax machine 5a. The fax would be stored on facsimile server 3a operated by, for example, a company involved in mortgage lending, and then be forwarded to mediation web server 1 operated, for example, by a telecommunications services company or the like. Thereafter, as explained in more detail below, the mediation web server 1 would process the incoming message in order to, for example, determine the name of the customer. Once that is determined, the mediation web server 1 may compare this name to a list of references representing the names of all customers having messages stored within databases 2a, . . . 2n. If a match occurs then the mediation web server 1 would thereafter store the present incoming message within the appropriate database 2a, . . . 2n which already contains related, previous messages from the same customer. If there is no matching reference, then the mediation web server 1 is operable to assign the incoming message to a record or the like within one of the databases 2a, . . . 2n which will be used to store the present, incoming message and all future messages relating to the same customer, for example.

Again, the examples just given are for illustrative purposes only. In no way should they be viewed as encompassing all of the features of the present invention.

In another embodiment of the present invention, once the mediation web server 1 has forwarded a message on to a database 2a, . . . 2n, it is operable to forward an acknowledgment or confirmation message (hereafter “confirmation message”) back to the customer and on to a customer agent 4 (e.g., a device used by a customer agent).

Once the customer agent 4 receives the confirmation message, the customer agent 4 may carry out further processes in order to respond to the customer's message. For example, a customer agent 4 might retrieve information from one or more of the databases 2a, . . . 2n directly from the databases or via mediation web server 1 in order to access an entire history of messages relating to one transaction or customer. Because all of the messages relating to a given customer or transaction, regardless of whether they are input initially via a fax machine 5a, desktop computer 5b, or telephone 5n, or some other device are all stored in one or more organized, easy-to-access databases 2a, . . . 2n. The customer agent 4 has the ability to view on a display or the like all of the messages that have been sent from, and to, the customer.

As to the latter, though not shown in FIG. 1, the mediation web server 1 can be connected to control communication devices and input devices used by, or on behalf of, the company to send customer agent messages to customers. That is to say, the mediation web server 1 is capable of identifying, storing and eventually comparing messages from customers to the company, and from the company (e.g., customer agents) to customers. Regardless of the direction of the flow, all messages may be stored in an appropriate database or databases 2a, . . . 2n in an organized, and easy-to-access manner.

After a customer agent views or otherwise receives messages relating to a customer or transaction, the agent may then request additional information from the customer directly or via the mediation server 1.

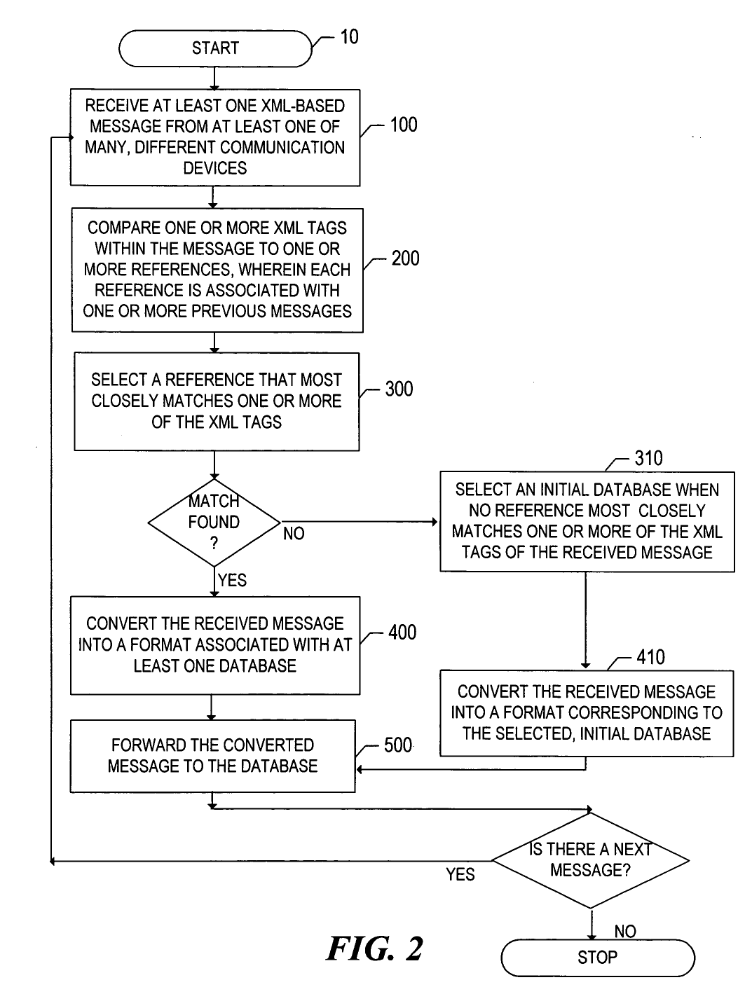

In order to allow the mediation web server 1 to store communications from many different input communication devices that make use of different formats, the present embodiment envisions a server 1 that is operable to send and receive XML messages or scripts. Referring now to FIG. 2, in more detail the mediation web server 1 is operable to receive at least one XML-based message from any one of the many different communication control devices 3a, 3b, . . . 3n at step 100. XML is a highly flexible messaging format that allows information formatted in one of many formats (e.g., fax, email, voicemail) to be exchanged and extracted by different devices. A detailed discussion of XML and its ability to allow diverse devices (e.g., servers) to exchange information is beyond the scope of the present disclosure. Suffice it to say that XML is a well-known messaging format.

Upon receiving one or more XML messages the mediation web server 1 is further operable to compare one or more XML tags within a received message to one or more references, where each reference is associated with one or more previously received messages stored in one or more databases 2a, . . . 2n at step 200. In one embodiment of the present invention, the mediation web server 1 is operable to select a reference that most closely matches one or more of the XML tags embedded in the XML message at step 300. An example of an XML tag may be the name and address of a customer.

Upon determining that one of the references matches one or more of the XML tags, the mediation web server 1 is operable to convert the received, XML message into a syntax and protocol (hereafter collectively referred to as a “format”) corresponding to the database or databases 2a, . . . 2n associated with the matching reference at step 400. For example, if the database is an Oracle-based database, then the mediation web server 1 is operable to convert the received message (whether it be a fax, email, voicemail, etc. . . , message) into an Oracle-based message so it can be stored in the Oracle database. Similarly, if the database is a Sybase database, the mediation web server 1 is operable to convert a received message into a Sybase formatted message. It should be understood that although only two types of databases are mentioned above, that there are other types of databases that could also be used to store customer messages and information (e.g., MySQL, MsQL, DB2, etc. . . ).

After converting a message to an appropriate format, the mediation web server 1 is further operable to forward the converted message to the appropriate database or databases at step 500. The use of XML-based messages allows communications in varied, original formats to be processed by the mediation web server 1. Some details concerning this processing will be discussed below. For now, suffice it to say that XML-based messages received by the mediation web server 1 comprise a unique Document Type Definition (“DTD”). Upon receiving each XML-based message, the mediation web server 1 parses or otherwise processes each message in accordance with the DTD. It is during this parsing or processing of each XML-based message that the mediation web server 1 is able to identify or otherwise locate the XML tags embedded in each message and then compare such tags to references corresponding to previous messages or message identifiers.

Each message which is sent from an input communication device 5a, 5b, . . . 5n is treated in substantially the same manner. For example, when a “next” message is sent the mediation web server 1 is operable to carry out substantially the same functions as indicated above. Namely, after receiving the next XML-based message, it compares next XML tags within the next XML-based message to references associated with previously received messages. Thereafter, it selects a reference that most closely matches one or more of the next XML tags and stores the next message in an appropriate, associated database or databases after the next message undergoes a conversion process.

It should be understood that related messages need only be substantially related to another, that is, each message need not contain all of the same XML tags. For example, one message may contain the name and address of a customer, while a next, related message may contain the same name and address but additional information. In this case, because the name and address would be coded as identical XML tags, these messages would be substantially related to one another.

Sometimes the next message does not contain XML tags which match the tags of a previous message (i.e., its not related to a previous message). Other times, the mediation web server 1 may not be able to identify or access an existing or associated database(s). When this occurs, the mediation web server 1 is operable to select an initial database at step 310 and, thereafter, convert the received, next message (or a first message for that matter) into a format associated with the selected initial database at step 410 and forward it on to the selected database at step 500. In sum, the mediation web server 1 is operable to carry out the same functions as described above except for the fact that it has to select an initial database.

Up until now it has been assumed that each of the control communication devices 3a, 3b, . . . 3n is capable of generating XML-based messages in response to an XML-based message sent from the mediation web server 1. This may not always be the case. In yet a further embodiment of the present invention, if a communication control device 3a, 3b, . . . 3n is not capable of generating XML-based messages, it must be upgraded to such a capability. Further still, if a communication control device 3a, 3b, . . . 3n, is capable of XML-based programming, it still may need to be programmed to format XML messages using the specified DTD. For example, an email server may need to be re-programmed to accept, process and forward XML-based messages using a specific DTD. This re-programming is typically done on site, but may in some cases be done remotely using online techniques (e.g., administrative login procedures). After a control device 3a,3b, . . . 3n has been re-programmed it is then operable to communicate using XML-based messages using a specific DTD.

Assuming a control device is capable of receiving and processing XML-based messages, the mediation web server 1 is operable to send XML-based request messages using a specific DTD to a control device 3a,3b, . . . 3n in order to obtain a particular customer communication (e.g., email, facsimile, voicemail, etc. . . ). In response, the control device receiving such a request is operable to forward a responsive XML-based message formatted using the specific DTD and associated with a customer communication. The responsive message is eventually received by the mediation web server 1 (after, sometimes, traversing one or more intermediate devices or connections).

An example of a DTD which may be used by the mediation web server 1 and control devices 3a, 3b, . . . 3n is shown in Table 1.

TABLE 1
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>

One of the advantages provided by the disclosed system is that it enables related, but distinct, communications to be received, identified and stored without the need to involve a live, customer agent. This frees up such agents to do other customer-related functions. It also allows customer agents to receive organized records of all of the communications sent by, or to, a given customer concerning a given transaction or subject matter. As provided by the present disclosure, the mediation web server 1 may generate a confirmation message immediately upon storing an incoming message or sometime thereafter. In a further embodiment of the present invention, the customer agent 4 is operable to sort or otherwise filter out certain messages before, or after, they are stored in database 2a, . . . 2n. That is to say, the mediation web server 1 may be further operable to query, or receive instructions from, the customer agent 4. These queries or instructions may direct the mediation web server 1 to store only certain types of messages in the databases 2a, . . . 2n or to forward only certain types of messages (e.g., voicemail, facsimile, email, Internet messages) on to the customer agent 4. For example, suppose customer agent 4 wishes to receive only emails concerning a certain transaction by a certain customer. In this instance, the mediation web server 1 is operable to forward to the customer agent 4 only those messages which are stored in databases 2a, . . . 2n that comprise appropriate emails. Alternatively, the mediation web server 1 may receive an instruction from the customer agent 4 to only store emails concerning certain transactions from a certain customer.

The above discussion has sought to set forth some exemplary embodiments of the present invention. The features and functions set forth above may be offered by a telecommunications services company or the like to business or residential customers. For example, the mediation web server 1 and control devices 3a,3b, . . . 3n may be operated by such a company. Likewise, the customer agent may be employed by a telecommunications services company.

Modifications and changes may be made to the methods, systems and devices described above without departing from the spirit or scope of the present invention. It should be further understood that the examples and features discussed above in no way limit the spirit or scope of the present invention, regardless as to whether or not such examples or features are contained in the claims that follow.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for organizing related communications in one or more databases comprising:
receiving at least one XML-based message from at least one of many, different communication devices;
comparing one or more XML tags within the at least one XML-based message to one or more references, wherein each reference is associated with one or more previous messages;
selecting a reference that most closely matches one or more of the XML tags;
converting the received message into a converted message having a format associated with at least one database associated with the matching reference; and
forwarding the converted message to the associated database.

2. The method as in claim 1, wherein the received message and a previous message corresponding to the selected reference are substantially related to one another.

3. The method as in claim 1, further comprising enabling a telecommunications service that organizes related communications in one or more databases.

4. The method as in claim 1, further comprising:
converting a next message into a same format as the converted message when the next message has one or more XML tags that match the XML tags of a previous message; and
forwarding the next, converted message to a database associated with the converted message.

5. The method as in claim 1, wherein the at least one received XML-based message comprises a Document Type Definition (“DTD”) which substantially takes the form of:
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>

6. The method as in claim 1, further comprising:
selecting an initial database when no reference most closely matches one or more of the XML tags of the received message;
converting the received message into a format corresponding to the selected, initial database; and
forwarding the converted message to the selected, initial database.

7. The method as in claim 1, further comprising:
forwarding an XML-based message comprising a DTD which substantially takes the form of:
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>
to at least one of the many, different communication devices.

8. The method as in claim 1, wherein the different communication devices are selected from the group consisting of a voicemail server, a facsimile server, an email server, and a web server.

9. The method as in claim 1, wherein the database format is selected from the group consisting of Oracle, Sybase, MySQL, MsQL, and DB2.

10. The method as in claim 1, further comprising:
forwarding a responsive XML-based message comprising a DTD which substantially takes the form of
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>
to a mediation web server.

11. The method as in claim 1, further comprising:
forwarding a confirmation message to at least one of the group consisting of a customer agent and a customer.

12. The method as in claim 1, further comprising:
forwarding certain types of related messages to a customer agent, wherein the message types are selected from the group consisting of voicemail, facsimile, email and Internet messages.

13. The method as in claim 1 further comprising:
receiving at least one XML-based message from a customer agent;
comparing one or more XML tags within the at least one XML-based message to one or more references, wherein each of the one or more references is associated with one or more previous messages;
selecting a reference that most closely matches one or more of the XML tags;
converting the received message into a converted message having a format associated with the matching reference; and
forwarding the converted message to the associated database.

14. A system for organizing related communications in one or more databases, the system comprising:
a mediation web server operable to:
receive at least one XML-based message from at least one of many, different communication devices;
compare one or more XML tags within the message to one or more references, wherein each reference is associated with one or more previous messages;
select a reference that most closely matches one or more of the XML tags;
convert the received message into a format associated with at least one database associated with the matching reference; and
forward the converted message to the associated database.

15. The system as in claim 14, wherein the received message and a previous message corresponding to the selected reference are substantially related to one another.

16. The system as in claim 14, wherein the web server is further operable to enable a telecommunications service that organizes related communications in one or more databases.

17. The system as in claim 14, wherein the web server is further operable to:
convert a next message into a same format as a previously converted message when the next message's one or more XML tags match the XML tags of a previous message; and
forward the next, converted message to a same database associated with the previously converted message.

18. The system as in claim 14, wherein the at least one received XML-based message comprises a Document Type Definition (“DTD”) which substantially takes the form of:
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>

19. The system as in claim 14, wherein the web server is further operable to:
select an initial database when no reference most closely matches one or more of the XML tags of the received message;
convert the received message into a format corresponding to the selected, initial database; and
forward the converted message to the selected, initial database.

20. The system as in claim 14, wherein the web server is further operable to:
forward an XML-based message comprising a Document Type Definition (“DTD”) which substantially takes the form of:
<!DOCTYPE GDS [
<!ELEMENT Correspondence (Envelope+,CallHistory+)>
<!ELEMENT Envelope (Sender, Receiver, Subject, ReceiptDate, Content,
ContentType)>
<!ELEMENT CallHistory (ContactDate,AgentComments)>
<!ELEMENT Sender (#PCDATA)>
<!ELEMENT Receiver(#PCDATA)>
<!ELEMENT Subject(#PCDATA)>
<!ELEMENT ReceiptDate (#PCDATA)>
<!ELEMENT Content (#PCDATA)>
<!ATTLIST ContentType CType CDATA #REQUIRED>
]>
to at least one of the many, different communications devices.

21. The system as in claim 14 wherein the database format is selected from the group consisting of Oracle, Sybase and MySQL, MsQL, DB2.

22. The system as in claim 14 further comprising:
at least one communications control device responsive to the mediation web server, the communication control device operable to forward a responsive XML-based message comprising a Document Type Definition.

23. The system as in claim 22, wherein the communication control device is selected from the group consisting of a voicemail server, a facsimile server, an email server, and a web server.

24. The system as in claim 14 wherein the web server is further operable to forward a confirmation message to at least one of the group consisting of a customer agent and a customer.

25. The system as in claim 14 wherein the web server is further operable to forward certain types of related messages to a customer agent, wherein the message types are selected from the group consisting of voicemail, facsimile, email and Internet messages.

26. The system as in claim 14 wherein the web server is further operable to:
receive at least one XML-based message from a customer agent;
compare one or more tags within the message to one or more references, wherein each reference is associated with one or more previous messages;
select a reference that most closely matches one or more of the XML tags;
convert the received message into a format associated with the matching reference; and
forward the converted message to the associated database.
